(19) United States
(12) Patent Application Publication
(10) Pub. No.: US 2022/0223400 A1
(43) Pub. Date: Jul. 14, 2022

(54) IONIZER AND IMS ANALYZER

(71) Applicant: SHARP KABUSHIKI KAISHA, Sakai City (JP)

(72) Inventors: Shunsuke MATSUO, Sakai City (JP); Masamitsu MORITANI, Sakai City (JP); KOHJI SHINKAWA, Sakai City (JP); TADASHI IWAMATSU, Sakai City (JP)

(21) Appl. No.: 17/569,942

(22) Filed: Jan. 6, 2022

(30) Foreign Application Priority Data
Jan. 13, 2021 (JP) 2021-003526

(51) Int. Cl. H01J 49/16

(52) U.S. Cl. CPC H01J 49/168

(57) ABSTRACT

An ionizer of the present invention includes a housing, an electron discharge element arranged in the housing, a controller, and a gas introduction, wherein the electron discharge element has a bottom electrode, a surface electrode, and an intermediate layer arranged between the bottom electrode and the surface electrode, and the controller is so set as to apply a voltage to across the bottom electrode and the surface electrode, and so set as to execute a forming process when an electron discharge performance of the electron discharge element is decreased, and the forming process is a process of applying, in a state where a forming process gas is introduced into the housing by using the gas introduction, a forming voltage to across the bottom electrode and the surface electrode using the controller.

### BACKGROUND OF THE INVENTION

### Field of the Invention

The present invention relates to an ionizer and an IMS analyzer.

### Description of the Background Art

IMS (Ion Mobility Spectrometry) is an art for ionizing a substance and measuring the ion mobility in a gas there by to analyze the composition of a target substance, and radioactive substance, corona discharge, and deep ultraviolet ray have been used as an ionization source thereof.

The radioactive substance, however, needs caution and supervision peculiar to the handling of such substance, and the corona discharge releases a high energy during the ionization thereby to generate unnecessary ions and may change a to-be-measured substance in quality thereby to adversely affect the measurement. A method of using the deep ultraviolet ray has an issue that an ionizable subject is restricted by the wavelength of the ultraviolet ray.

As an ionization method for solving these problems, a method of using an electron discharge element as an ionization source for an IMS analyzer (see, for example, Japanese Unexamined Patent Application Publication No. 2019-186190) has been proposed.

In the IMS measurement using the electron discharge element, there is an issue that the output of the electron discharge element (electron discharge performance) decreases as the measurement proceeds. In the conventional measurement method, when the output of the electron discharge element decreases, the electron discharge element is replaced. Due to this, every time the output of the electron discharge element decreases, the element is replaced, which causes a temporary stop to the measurement.

In view of these issues, the present invention has been made, and provides an ionizer which can decrease the frequency of replacing an electron discharge element.

### SUMMARY OF THE INVENTION

The present invention provides an ionizer, including: a housing; an electron discharge element arranged in the housing; a controller; and a gas introduction, wherein the electron discharge element has a bottom electrode, a surface electrode, and an intermediate layer arranged between the bottom electrode and the surface electrode, and the controller is so set as to apply a voltage to across the bottom electrode and the surface electrode, and so set as to execute a forming process when an electron discharge performance of the electron discharge element is decreased, and the forming process is a process of applying, in a state where a forming process gas is introduced into the housing by using the gas introduction, a forming voltage to across the bottom electrode and the surface electrode using the controller.

The controller included in the ionizer of the present invention is so set as to execute, when an electron discharge performance of the electron discharge element is decreased, a process (forming process) which applies, in a state where a forming process gas is introduced into the housing by using the gas introduction, a forming voltage to across the bottom electrode and the surface electrode of the electron discharge element. This forming process can recover the electron discharge performance of the electron discharge element. This has been clarified by experiments conducted by the inventor and the like of the present application and others.

This forming process can decrease the frequency of replacing the electron discharge element, making it possible to execute measurements for a long time. In addition, the running cost of the ionizer can be decreased. In addition, changing of the environment in the housing due to the replacing of the electron discharge element can be suppressed, making it possible to improve the measurement efficiency.

### BRIEF DESCRIPTION OF THE DRAWINGS

FIG. 1 is a schematic cross-sectional view of an IMS analyzer (including an ionizer of the present invention) of one embodiment of the present invention.

FIG. 2 is a control flowchart of the IMS analyzer of the one embodiment of the present invention.

FIG. 3 is a control flowchart of the IMS analyzer of the one embodiment of the present invention.

FIG. 4 is a graph showing the change in the total peak area of the current waveform measured in a first IMS experiment.

FIG. 5 is a graph showing the current waveform measured in the first IMS experiment.

FIG. 6 is a graph showing the change in the peak height of the current waveform measured in the first demonstrative experiment of a forming process.

FIG. 7 is a graph showing the current waveform measured in the first demonstrative experiment of the forming process.

FIG. 8 is a graph showing the change in the total peak area of the current waveform and the change in the element drive voltage measured in a second IMS experiment.

FIG. 9 is a graph showing the change in the total peak area of the current waveform and the change in the element drive voltage measured in a second demonstrative experiment of the forming process.

### DESCRIPTION OF THE PREFERRED EMBODIMENTS

An ionizer of the present invention, includes: a housing; an electron discharge element arranged in the housing; a controller; and a gas introduction, wherein the electron discharge element has a bottom electrode, a surface electrode, and an intermediate layer arranged between the bottom electrode and the surface electrode, and the controller is so set as to apply a voltage to across the bottom electrode and the surface electrode, and so set as to execute a forming process when an electron discharge performance of the electron discharge element is decreased, and the forming process is a process of applying, in a state where a forming process gas is introduced into the housing by using the gas introduction, a forming voltage to across the bottom electrode and the surface electrode using the controller.

It is preferable that the forming process gas is a gas having a relative humidity of 60% or more or a gas including ethanol. This can effectively recover the electron discharge performance of the electron discharge element.

It is preferable that the controller is so set as to apply a voltage of a first voltage or more to a second voltage or less to across the bottom electrode and the surface electrode thereby to discharge an electron from the electron discharge element, thus directly or indirectly ionizing a target gas with the electron, and so set as to, in the forming process, apply a voltage more than the second voltage to across the bottom electrode and the surface electrode. This can effectively recover the electron discharge performance of the electron discharge element.

It is preferable that, in the forming process, the controller is so set as to increase, step by step at a boost rate of 0.05 V/sec or more to 1 V/sec or less, the forming voltage applied to across the bottom electrode and the surface electrode. This can suppress the electron discharge element from being damaged in the forming process.

It is preferable that, in the forming process, the controller is so set as to repeatedly switch on and off, at a frequency of 500 Hz or more to 5000 Hz or less, the forming voltage applied to across the bottom electrode and the surface electrode. This can effectively recover the electron discharge performance of the electron discharge element.

It is preferable that the intermediate layer is a silicone resin layer having silver particles in a dispersed state.

The present invention also provides an IMS analyzer equipped with the ionizer, a collector, and an electric field former of the present invention. It is preferable that the electric field former is so set as to form an electric field in an ion mobile area in which ions directly or indirectly generated by electrons discharged from the electron discharge element move toward the collector, and it is preferable that the collector and the controller are so set as to measure a current waveform of the current caused to flow as the ions arrive at the collector.

It is preferable that the controller is so set as to adjust, based on the current waveform, the applied voltage to across the bottom electrode and the surface electrode. This makes it possible to stabilize and quantitatively measure the current waveform repeatedly measured.

It is preferable that the controller is so set as to increase the applied voltage to the bottom electrode and the surface electrode when the peak area or peak height of the current waveform becomes less than a predetermined value (target lower limit). This allows a larger amount of electrons to be discharged from the electron discharge element, and a larger ion amount to arrive at the collector. With this, the peak area or peak height of the current waveform is more than the target lower limit, and the peak area or peak height can be made within the target range.

It is preferable that the controller is so set as to execute the forming process when the peak area or peak height of the current waveform in the measurement immediately after increasing the applied voltage to the bottom electrode and the surface electrode becomes less than the predetermined value (target lower limit). Usually, when the applied voltage to the bottom electrode and surface electrode is increased, the peak area or peak height of the current waveform in the immediately-after measurement becomes more than the target lower limit. However, when the electron discharge performance of the electron discharge element is decreased by repeated IMS measurements, the peak area or peak height does not become larger even if the applied voltage to the bottom electrode and surface electrode is increased. In this manner, the forming process is executed when the decrease in the electron discharge performance of the electron discharge element is detected, thereby making it possible to improve the electron discharge performance of the electron discharge element.

An embodiment of the present invention will be described below using the drawings. Drawings and any constitution which is shown in the following description are merely exemplifications, to which the scope of the present invention is in no way limited.

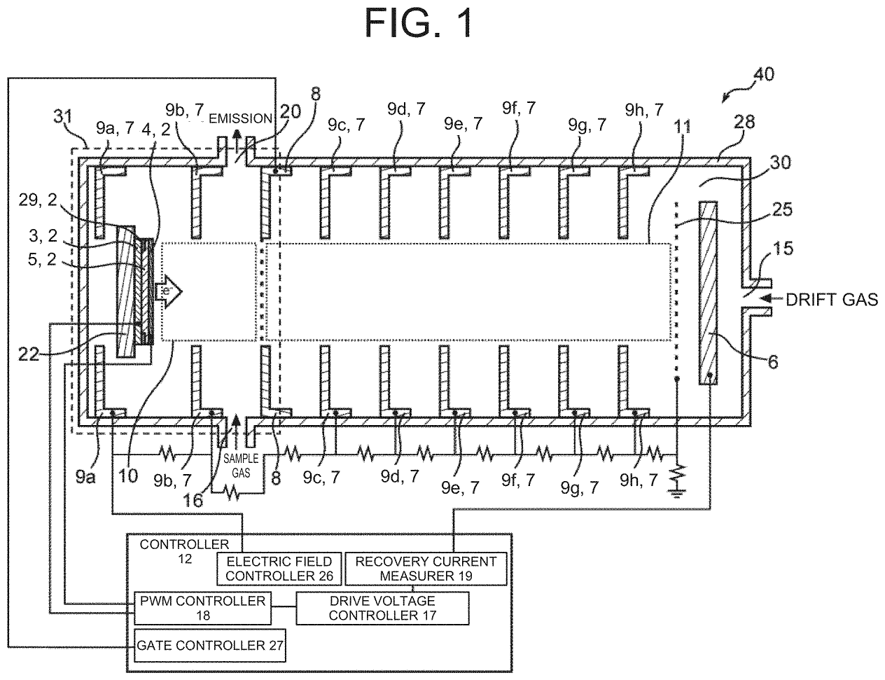

FIG. 1 is a schematic cross-sectional view of an IMS analyzer including an ionizer of the present embodiment. FIG. 1 also shows a block diagram of the electrical configuration of the IMS analyzer.

An ionizer 31 of the present embodiment includes: a housing 28, an electron discharge element 2 arranged in the housing 28, a controller 12, and a gas introduction 16, wherein the electron discharge element 2 has a bottom electrode 3, a surface electrode 4, and an intermediate layer 5 arranged between the bottom electrode 3 and the surface electrode 4, and the controller 12 is so set as to apply a voltage to across the bottom electrode 3 and the surface electrode 4, and so set as to execute a forming process when an electron discharge performance of the electron discharge element 2 is decreased, and the forming process is a process of applying, in a state where a forming process gas is introduced into the housing 28 by using the gas introduction 16, a forming voltage to across the bottom electrode 3 and the surface electrode 4 using the controller 12.

The ionizer 31 is a device that ionizes gas. The ionizer 31 may be incorporated in an IMS analyzer 40, or may be incorporated in a mass analyzer. Herein described is an IMS analyzer in which the ionizer 31 is incorporated.

The IMS analyzer 40 of the present embodiment includes the ionizer 31, a collector 6, and an electric field former 7, wherein the electric field former 7 is so set as to form an electric field in an ion mobile area 11 where an ion directly or indirectly generated by an electron discharged from the electron discharge element 2 moves toward the collector 6, and the collector 6 and a controller 12 are so set as to measure a current waveform of a current caused to flow as the ion arrives at the collector 6.

The IMS analyzer 40 is a device that analyzes a sample by ion mobility spectrometry (IMS). The analyzer 40 may be an ion mobility spectrometer. The analyzer 40 may be an IMS analyzer that makes an analysis with a drift tube-method IMS, and may be an IMS analyzer that makes an analysis with a field asymmetric IMS (FAIMS). The present embodiment describes an IMS analyzer that makes an analysis with the drift tube-method IMS.

The sample gas to be analyzed by the IMS analyzer 40 may be a gaseous sample or a sample of vaporized liquid.

The controller 12 is a part that controls the IMS analyzer 40. The controller 12 can include a microcontroller having a central processing unit (CPU), a storage, a timer, and an input and output port, for example. The controller 12 may also include a computer. The controller 12 may also include an electric field controller 26, a gate controller 27, a drive voltage controller 17, a PWM controller 18, a recovery current measurer 19, a power supply, and the like.

The drive voltage controller 17 and the PWM controller 18 are so set as to control the electron discharge of the electron discharge element 2, and the gate controller 27 is so set as to control the opening and closing of an electrostatic gate electrode 8.

The IMS analyzer 40 of the present embodiment has an analysis chamber 30 (inside the housing 28) for analyzing a to-be-detected component included in the sample gas, the analysis chamber 30 has an ionization area 10 for ionizing the to-be-detected component included in the sample gas thereby to generate ions (negative ions or positive ions), and the ion mobile area 11 (drift region) for moving and separating the ions, between the electron discharge element 2 and the collector 6. The ionization area 10 and the ion mobile area 11 are partitioned from each other by the electrostatic gate electrode 8. Further, at the ionization area 10's end opposite to the electrostatic gate electrode 8, the electron discharge element 2 is arranged so that the surface electrode 4 is on the ionization area side. At the ion mobile area 11's end opposite to the electrostatic gate electrode 8, the collector 6 is arranged.

The gas introduction 16 (sample injector 16) is a portion that injects the sample gas or the forming process gas into the analysis chamber 30. During the analyzing of the sample gas, the sample gas is injected into the analysis chamber 30 from the gas introduction 16. During the forming process, the forming process gas is injected into the analysis chamber 30 from the gas introduction 16. The gas introduction for injecting the sample gas and the gas introduction for injecting the forming process gas may be separately provided. The forming process gas may be injected into the analysis chamber 30 from a drift gas injector 15. In this case, the drift gas injector 15 serves as the gas introduction.

The to-be-detected component included in the sample gas injected from the gas introduction 16 (sample injector 16) into the analysis chamber 30 is analyzed by the ion mobility analysis. When the sample is a gas, the sample injector 16 can be so set as to continuously supply the sample gas to the analysis chamber 30. When the sample is a liquid, the sample injector 16 can have a vaporization chamber, and can inject, into the analysis chamber 30, the sample gas vaporized by the vaporization chamber.

The drift gas injector 15 is a part so set as to inject the drift gas into the analysis chamber 30. The drift gas is a gas that flows in the ion mobile area 11 in a direction opposite to the ion mobile direction and is a gas that serves as a resistance when ions move through the ion mobile area 11. The drift gas may be air (purified air) obtained by purification of atmospheric air, air supplied from a compressed air cylinder, or air discharged by an exhauster 20 from the analysis chamber 30 and then purified.

The exhauster 20 is a part so set as to exhaust a gas in the analysis chamber 30. The exhauster 20 is so set as to exhaust the drift gas and the sample gas from the analysis chamber 30. The exhauster 20 may be so set as to forcibly exhaust the gas in the analysis chamber 30 with an emission fan or the like or may be so set as to automatically exhaust the gas in the analysis chamber 30.

The sample injector 16 and the exhauster 20 can be so set that the sample gas may flow in the ionization area 10. With this, electrons discharged from the surface electrode 4 of the electron discharge element 2 in the ionization area 10 can directly or indirectly ionize the component included in the sample gas thereby to generate negative ions or positive ions.

The drift gas injector 15 and the exhauster 20 are so set that the drift gas may flow in the ion mobile area 11 from the collector side toward the electrostatic gate electrode side. For example, the drift gas injector 15 can be so set as to supply the drift gas from the collector side to the ion mobile area 11, and the exhauster 20 can be so set as to exhaust the drift gas through an opening (gas outlet) in the housing 28 around the ionization area 10.

The electron discharge element 2 is an element so set as to discharge electrons from the surface electrode 4, and is an element for directly or indirectly ionizing, by the discharged electrons, the to-be-detected component included in the sample gas thereby to generate negative ions or positive ions.

The electron discharge element 2 includes the bottom electrode 3, the surface electrode 4, and the intermediate layer 5 arranged between the bottom electrode 3 and the surface electrode 4.

The surface electrode 4 is an electrode located on the surface of the electron discharge element 2. The surface electrode 4 preferably has a thickness of 10 nm or more to 100 nm or less. The material for the surface electrode 4 is gold or platinum, for example. The surface electrode 4 may be composed of a plurality of metal layers.

Even when having a thickness of 40 nm or more, the surface electrode 4 may have a plurality of openings, gaps, or thinned portions with a thickness of 10 nm or less. The electrons, which have flowed through the intermediate layer 5, are able to pass through or permeate such openings, gaps or thinned portions, making it possible to discharge electrons from the surface electrode 4. The openings, gaps or thinned portions as above may also be formed by applying a voltage to across the bottom electrode 3 and the surface electrode 4.

The bottom electrode 3 is an electrode facing the surface electrode 4 via the intermediate layer 5. The bottom electrode 3 may be a metal plate, or a metal layer or conductor layer that is formed on an insulating substrate or on a film. If the bottom electrode 3 is composed of the metal plate, the metal plate may be a substrate of the electron discharge element 2. Examples of the material for the bottom electrode 3 include aluminum, a stainless steel, and nickel. The thickness of the bottom electrode 3 is 200 μm or more to 1 mm or less, for example.

The intermediate layer 5 is a layer through which electrons flow due to the electric field formed by applying the voltage to across the surface electrode 4 and the bottom electrode 3. The intermediate layer 5 can be semiconductive. The intermediate layer 5 can include at least one of an insulating resin, an insulating fine particle, and a metal oxide. The intermediate layer 5 preferably includes conductive fine particles. The thickness of the intermediate layer 5 can be 0.5 μm to 1.8 μm. The intermediate layer 5 is, for example, a silicone resin layer having silver fine particles in a dispersed state.

The electron discharge element 2 may include an insulative layer 29 between the surface electrode 4 and the bottom electrode 3. The insulative layer 29 can have an opening. The opening of the insulative layer 29 is so set as to define an electron discharge region of the surface electrode 4. Since electrons cannot flow through the insulative layer 29, electrons flow through the intermediate layer 5 which corresponds to the opening of the insulative layer 29, and are discharged from the surface electrode 4. Accordingly, providing the insulative layer 29 having the opening defines the electron discharge region to be formed in the surface electrode 4. The electron discharge region can be made five millimeters square, for example, and can be freely designed according to an opening portion of an electric field forming electrode 9 and to the size of the collector 6.

The surface electrode 4 and the bottom electrode 3 can be each electrically connected to the controller 12 (PWM controller 18, and drive voltage controller 17).

The drive voltage controller 17 is so set as to control the magnitude of the voltage (drive voltage of the electron discharge element 2) applied to across the surface electrode 4 and the bottom electrode 3. When the drive voltage controller 17 is used thereby to make the potential of the bottom electrode 3 substantially the same as the potential of the surface electrode 4 (the drive voltage is set to 0 V), no current flows through the intermediate layer 5 and no electrons are discharged from the electron discharge element 2.

Using the drive voltage controller 17 thereby to apply the voltage (drive voltage) to across the bottom electrode 3 and the surface electrode 4 so that the potential of the bottom electrode 3 becomes lower than the potential of the surface electrode 4 flows the current through the intermediate layer 5, and allows electrons, which flow through the intermediate layer 5, to pass through the surface electrode 4 and to be discharged to the ionization area 10. The voltage applied to across the bottom electrode 3 and the surface electrode 4 in order to cause the electron discharge element 2 to discharge electrons can be 5 V or more to 40 V or less.

Adjusting the magnitude of the drive voltage by using the drive voltage controller 17 changes the current flowing through the intermediate layer 5, and changes the amount of electrons discharged from the electron discharge element 2. The energy of the electrons discharged from the electron discharge element 2 also changes.

The PWM controller 18 is a part in which the drive voltage controller 17 changes and modulates the duty ratio of the periodic pulse wave of the voltage (drive voltage) applied to the surface electrode 4 and the bottom electrode 3. The PWM controller 18, by adjusting the duty ratio of the voltage supplied to the electron discharge element 2 (by PWM control) changes the current flowing in the intermediate layer 5 between the surface electrode 4 and the bottom electrode 3 changes, and changes the amount of electrons discharged from the electron discharge element 2. The duty ratio (duty cycle) is a percentage of the time (pulse width) at which the pulse of the voltage applied to the surface electrode 4 and the bottom electrode 3 stays at its maximum value, relative to the frequency.

After the supply of the drift gas (dry air) to the analysis chamber 30 is started and before the supply of the sample gas to the ionization area 10 is started, discharging electrons from the electron discharge element 2 to the ionization area 10 causes the electrons to immediately collide with the air components thereby to form primary ions (negative ions or positive ions). When the electrons discharged from the electron discharge element 2 adhere to the gas components in the vicinity of the surface electrode 4 (electron attachment phenomenon), negative ions of the gas components are generated. When the energy of the electrons discharged from the electron discharge element 2 is higher than an ionization energy of the gaseous component in the vicinity of the surface electrode 4, positive ions of the gaseous component are generated.

The primary ions are, for example, oxygen ions obtained by ionization of oxygen gas in the air. At this time, the primary ions having an amount which accords to the electron discharge amount of the electron discharge element 2 are present in the ionization area 10. The amount of the primary ions in the ionization area 10, however, varies depending on environmental conditions, such as the temperature and the humidity, and on the life characteristics of the element.

The amount of primary ions can be adjusted by adjusting the voltage applied to across the surface electrode 4 and the bottom electrode 3, and the like (by adjusting the electron discharge amount of the electron discharge element 2).

After the supply of the drift gas into the analysis chamber 30 and the supply of the sample gas to the ionization area 10 are started, discharging electrons from the electron discharge element 2 to the ionization area 10 causes the electrons to immediately collide with air components thereby to form the primary ions (negative ions or positive ions). These primary ions, in the ionization area 10, receive and deliver an electric charge from/to the to-be-detected component included in the sample gas thereby to generate negative or positive ions of the to-be-detected component included in the sample gas (ion-molecule reaction). That is, using the electron discharge element 2 can indirectly generate, in the ionization area 10, negative or positive ions of the to-be-detected component included in the sample gas. In the ionization area 10, there are ions generated from the to-be-detected component included in the sample gas and primary ions.

The electric field former 7 is a part for forming a potential gradient in the region between the electron discharge element 2 and the collector 6. The electric field former 7 is so set as to form the potential gradient such that ions move from the electron discharge element side to the collector side. When the IMS analyzer 40 detects negative ions (negative ion mode), the controller 12 (electric field controller 26) applies the voltage to the electric field former 7 so that the potential gradient is formed such that the potential on the electron discharge element side is lower than the potential on the collector side. When the IMS analyzer 40 detects positive ions (positive ion mode), the controller 12 (electric field controller 26) applies the voltage to the electric field former 7 so that the potential gradient is formed such that the potential on the electron discharge element side is higher than the potential on the collector side.

The electric field former 7 may be composed of a plurality of electric field forming electrode 9a through 9h (hereinafter also referred to as electric field forming electrode 9). The electric field forming electrode 9 is not limited in shape as long as the potential gradient is formed in the region between the electron discharge element 2 and the collector 6, and may be an arch-shaped electrode. The electric field forming electrode 9 line up so that the ionization area 10 and the ion mobile area 11 (drift region) may be formed within a ring or inside an arch. Further, the electric field forming electrode 9, which is included in the electric field former 7, is electrically connected to the electric field controller 26 of the controller 12. Further, the surface electrode 4 or bottom electrode 3 of the electron discharge element 2 may function as the electric field former 7.

The electrostatic gate electrode 8 is an electrode that partitions the ionization area 10 and the ion mobile area 11, and controls, by using the electrostatic interaction between the ions and the electrostatic gate electrode 8, the injection of ions, which are generated in the ionization area 10, into the ion mobile area 11.

The electrostatic gate electrode 8 is, for example, a grid-shaped electrode (shutter grid). The electrostatic gate electrode 8 can be so arranged as to line up along with the electric field forming electrode 9 constituting the electric field former 7. The electrostatic gate electrode 8 can be electrically connected to the gate controller 27 of the controller 12. The electrostatic gate electrode 8 is so set as to be able to change the potential gradient formed by the electric field former 7.

The gate controller 27 changes the potential of the electrostatic gate electrode 8 in a manner to instantaneously change from the low potential side close (a state where, because the potential of the electrostatic gate electrode 8 is low, ions in the ionization area 10 cannot pass through the electrostatic gate electrode 8 and cannot move to the ion mobile area 11) to the high potential side close (a state where, because the potential of the electrostatic gate electrode 8 is high, the ions in the ionization area 10 cannot pass through the electrostatic gate electrode 8 and cannot move to the ion mobile area 11), or in a manner to instantaneously change from the high potential side close to the low potential side close. This allows the electrostatic gate electrode 8 to be in an open state for a very short time, and allows the ions in the ionization area 10 to be injected into the ion mobile area 11 for only this very short time. Therefore, ions in the ionization area 10 can be injected into the ion mobile area 11 in the form of a single pulse.

The negative ions or positive ions injected into the ion mobile area 11 move through the ion mobile area 11 toward the collector 6 by the potential gradient formed by the electric field former 7, and arrive at the collector 6. At this time, the negative or positive ions move against the drift gas flow. This drift gas flow serves as the resistance to the negative or positive ions moving from the electrostatic gate electrode 8 towards the collector 6. A magnitude of the resistance (ion mobility) depends on ion species. In general, mobility is inversely proportional to the collisional cross-sectional area of the ion (the size of ion), so the larger the collisional cross-sectional area of the ion, the longer it takes for the ion to arrive at the collector 6 (the larger the ion, the more frequently the ion collides with an air molecule in the drift gas, and thereby the slower the ion's mobile speed and the more delayed the ion arrives at the collector 6). Therefore, the time from when the ions are injected into the ion mobile area 11 by the electrostatic gate electrode 8 to when the ions arrive at the collector 6 (arrival time, peak position) differs depending on the ion species of negative or positive ions. Therefore, it is possible to specify negative ions or positive ions (to-be-detected component included in the sample) based on this arrival time (peak position). The ions of a plurality of to-be-detected components included in the sample gas can be separated in the ion mobile area 11.

The collector 6 is a metal member that collects the electric charge of negative or positive ions. The collector 6 can be electrically connected to the recovery current measurer 19 of the controller 12. The recovery current measurer 19 is so set as to measure, in a time series, the recovery current generated by the negative or positive ions delivering or receiving the electric charge to/from the collector 6. With this, it is possible to measure the current waveform of the recovery current.

A plurality of types of ions injected into the ion mobile area 11 in the form of single-shot pulses using the electrostatic gate electrode 8 are separated into various ions while moving through the ion mobile area 11, and various ions arrive at the collector 6 with a time shift. As a result of this, the current waveform of the recovery current shows a waveform having a peak that corresponds to the arrival time of various ions, and the mobility can be calculated from the peak position (arrival time), making it possible to discriminate the ion components. Since the peak height or peak area of the current waveform of the recovery current corresponds to the electric charge amount received or delivered by various ions from/to the collector 6, thus making it possible to subject the to-be-detected component to a quantitative analysis based on the peak height or the peak area.

The controller 12 may be so set as to adjust the applied voltage to across the bottom electrode 3 and the surface electrode 4 based on the current waveform of the recovery current. The controller 12 may be so set as to feedback-control the drive voltage of the electron discharge element 2 based on the current waveform of the recovery current. The adjustment of the applied voltage may be an adjustment, by the drive voltage controller 17, of the magnitude of the applied voltage, or an adjustment, by the PWM controller 18, of the duty ratio of the applied voltage.

Specifically, a target range is set for the peak height, peak area or total peak area of the peak appearing in the current waveform of the recovery current, and then the IMS analysis is repeated while adjusting (feedback-controlling), with the controller 12, the magnitude or duty ratio of the applied voltage to across the bottom electrode 3 and the surface electrode 4, so that the peak height, peak area or total peak area is within this target range. This can decrease the influence which is attributable to that the electron discharge performance of the electron discharge element 2 is decreased due to the repeated IMS measurements and which is given to the measurement result of the IMS analysis, thus making it possible to improve the quantitative characteristic of the measurement.

The cause of the decrease in the electron discharge performance of the electron discharge element 2 due to the repeated IMS measurements is unknown; however, it is deemed that is because the repeated IMS measurements decrease the current path formed in the intermediate layer 5 between the bottom electrode 3 and the surface electrode 4.

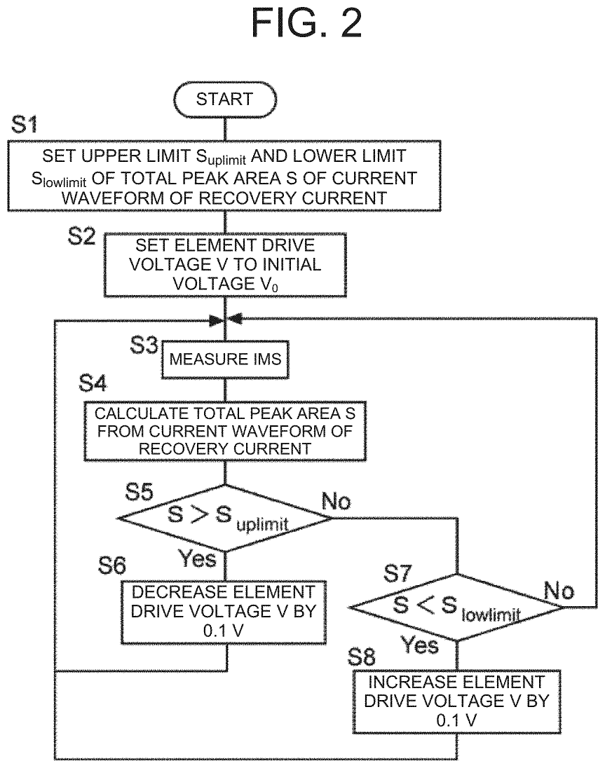

FIG. 2 is a flowchart of the feedback-control. Description will be made using this flowchart. Step S1 sets an upper limit Sᵤₚₗᵢₘᵢₜ and a lower limit S_{lowlimit} of a total peak area S of the current waveform of the recovery current. The range between Sᵤₚₗᵢₘᵢₜ and S_{lowlimit} is the target range. Next, an element drive voltage V (applied voltage to across the bottom electrode 3 and the surface electrode 4) of the electron discharge element 2 is set to Vo (step S2), the IMS measurement (step S3) is executed, and the total peak area S is calculated from the current waveform of the recovery current (step S4).

When the calculated total peak area S is more than Sᵤₚₗᵢₘᵢₜ (step S5), the element drive voltage V is decreased by 0.1 V (step S6), and the IMS measurement is executed again (step S3). When the element drive voltage V is decreased, the amount of electrons discharged by the electron discharge element 2 is decreased, and the total peak area S becomes less than that in the previous measurement. Such adjustment of the element drive voltage V is repeated until the total peak area S becomes less than Sᵤₚₗᵢₘᵢₜ.

When the calculated total peak area S is less than S_{lowlimit} (step S7), the element drive voltage V is increased by 0.1 V (step S8), and the IMS measurement is executed again (step S3). Increasing the element drive voltage V increases the electron discharge amount of the electron discharge element 2, and the total peak area S becomes more than that in the previous measurement. Such adjustment of the element drive voltage V is repeated until the total peak area S becomes more than S_{lowlimit}.

When the calculated total peak area S is within the target range (within the range between Sᵤₚₗᵢₘᵢₜ and S_{lowlimit}), the IMS measurement is repeated without changing the element drive voltage V.

Such feedback-control allows the ion amount, which arrives at the collector 6, to be within the target range, thereby improving the quantitative characteristic of the measurement. However, as the electron discharge performance of the electron discharge element 2 decreases through repeated IMS measurements, the element drive voltage V increases and reaches the upper limit.

Therefore, the IMS analyzer of the present embodiment is so set as to execute the forming process when the electron discharge performance of the electron discharge element 2 is decreased.

The forming process is a process in which a forming process gas is introduced into the housing 28 (analysis chamber 30) using the gas introduction 16, and a forming voltage is applied to across the bottom electrode 3 and the surface electrode 4 using the controller 12. Experiments conducted by the present inventor and the like have revealed that the electron discharge performance of the electron discharge element 2 can be recovered by such process. Although the mechanism by which the electron discharge performance of the electron discharge element 2 is recovered is not clear, it is conceived that the forming process increases the current path formed in the intermediate layer 5 between the surface electrode 4 and the bottom electrode 3.

The forming process gas is a gas used for the forming process. The forming process gas is, for example, a gas having a relative humidity of 60% or more (e.g., air having a relative humidity of 60% or more, preferably air having a relative humidity of 70% or more) or a gas including ethanol (e.g., air including ethanol). Further, the forming process gas can be supplied to the analysis chamber 30 so as to make the humidity of the ionization area 10 in the forming process be 60% or more.

The forming process can be executed as follows.

When it is detected that the electron discharge performance of the electron discharge element 2 has decreased (for example, when the total peak area S of the current waveform of the recovery current does not increase even when the element drive voltage is increased, or when the element drive voltage reaches the upper limit), supply of the gas from the gas introduction 16 to the analysis chamber 30 is stopped, repetition of the IMS measurement is interrupted, and the forming process gas is supplied from the gas introduction 16 into the housing 28 (analysis chamber 30) (when the sample gas functions as the forming process gas, the sample gas can be used as the forming process gas). With this, the forming process gas is distributed in the analysis chamber 30, and the forming process gas is supplied to the electron discharge element 2 arranged in the analysis chamber 30. In this state, the forming voltage is applied to across the bottom electrode 3 and the surface electrode 4 using the controller 12. This can recover the electron discharge performance of the electron discharge element 2. Thereafter, the supply of the forming process gas to the analysis chamber 30 is stopped, the supply of the sample gas to the analysis chamber 30 is restarted, and the repetition of the IMS measurement is restarted.

The supply start and supply stop of the forming process gas may be executed manually, or may be executed automatically by control with the controller 12.

In the forming process, the controller 12 can be so set as to apply the forming voltage to across the bottom electrode 3 and the surface electrode 4 which voltage is more than the upper limit voltage applied to across the bottom electrode 3 and the surface electrode 4 in the IMS measurement. This can more effectively recover the electron discharge performance of the electron discharge element 2.

In the forming process, the controller 12 may be so set as to increase, step by step at a boost rate of 0.05 V/sec or more to 1 V/sec or less (preferably in 10 steps or more), the forming voltage applied to across the bottom electrode 3 and the surface electrode 4. This can suppress an overcurrent from flowing in the intermediate layer 5 between the bottom electrode 3 and the surface electrode 4, thereby making it possible to suppress the electron discharge element 2 from being damaged. Further, the boost range of the forming voltage that boosts step by step may be gradually increased (the boost range is increased in an accelerated manner).

In the forming process, the controller 12 may be so set as to repeatedly switch on/off, at a frequency of 500 Hz or more to 5000 Hz or less, using the PWM controller 18, the forming voltage applied to across the bottom electrode 3 and the surface electrode 4. This can more effectively recover the electron discharge performance of the electron discharge element 2.

The forming process can be executed, for example, as follows.

First, for the forming voltage to be applied to across the bottom electrode 3 and the surface electrode 4; a start voltage [V], an end voltage [V], the number of boost steps, the drive frequency [Hz], the number of drive times in each step, and the voltage boost amount between steps are set (step A). For example, the start voltage can be set to 5 V, the end voltage can be set to 25 V, the number of boost steps can be set to 200 steps, the drive frequency can be set to 2000 Hz, the number of drive times in each step can be set to 2000 times, and the voltage boost amount between steps can be set to 0.1 V. The start voltage can also be set to 0 V. The end voltage can be 25 V or more to 30 V or less.

Next, the PWM frequency (duty ratio is, for example, 50%) of the forming voltage at the set drive frequency set using the PWM controller 18 is repeated by the set number of drive times (step B). When the drive frequency is 2000 Hz and the number of drive times in each step is 2000, the time required for each step is about 1 sec.

Next, after repeating the PWM frequency by the set number of times, the forming voltage is increased by the set voltage boost amount (step C), for example, the forming voltage is increased by 0.1 V.

Then, step B and step C are repeated until the forming voltage reaches the set end voltage.

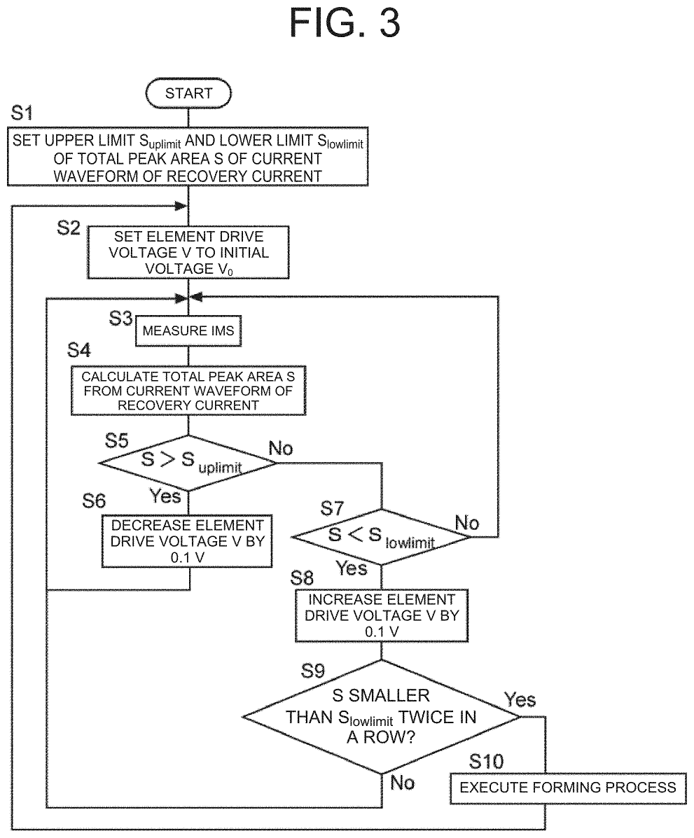

FIG. 3 is a flowchart of the feedback-control including the forming process. Steps S1 to S8 are the same as those of the feedback-control described using FIG. 2. In the feedback-control including the forming process, step S9 determines whether or not the calculated total peak area S has become less than S_{lowlimit} two times in a row. If it is determined that the calculated total peak area S is less than the S_{lowlimit} two times in a row, the forming process is executed (step S10). This can recover the electron discharge performance of the electron discharge element 2. Then, returning to steps S2 and S3 can restart repetition of the IMS measurement at the decreased element drive voltage V.

When it is determined in step S7 that the total peak area S becomes less than the S_{lowlimit}, the element drive voltage V is increased by 0.1 V in step S8. Normally, with this, the total peak area S calculated from the current waveform of the recovery current measured in the next IMS measurement (step S3) becomes more than the S_{lowlimit}. However, if the electron discharge performance of the electron discharge element is extremely decreased by the repeating of the IMS measurement (step S3), the total peak area S in the next IMS measurement hardly changes even when the element drive voltage V is increased in step S8. In this case, it is determined in step S9 that the total peak area S has become less than the S_{lowlimit} two times in a row. Therefore, in step S9, it can be detected that the electron discharge performance of the electron discharge element has been extremely decreased.

In this way, the forming process is executed when it is detected that the electron discharge performance of the electron discharge element 2 has been extremely decreased by repeated IMS measurements, so that the element drive voltage V can be decreased, and the IMS measurement can be repeated for a long period of time without replacing the electron discharge element 2. Therefore, the frequency of replacing the electron discharge element 2 can be decreased.

When the electron discharge performance of the electron discharge element 2 does not recover even after the forming process is executed (e.g., when the total peak area does not arrive at the S_{lowlimit} even when the element drive voltage V is increased, after the forming process is executed), the controller 12 informs an operator by means of an alarm display or the like that the electron discharge element 2 needs to be replaced.

First IMS Experiment

With the drift tube-method IMS analyzer as shown in FIG. 1, the IMS measurement was repeatedly executed for over a period of about 36 minutes. In the IMS measurement, the dry air as the drift gas was distributed to the analysis chamber 30 (500 ml/min), and the air including a pure water volatile gas as the sample gas was supplied to the analysis chamber 30 (200 ml/min). The electron discharge element 2 used is the one that is provided with, as the intermediate layer 5, the silicone resin layer having silver fine particles in the dispersed state. In addition, the voltage of 13 V was applied to across the bottom electrode 3 and the surface electrode 4 (drive frequency of 10 Hz).

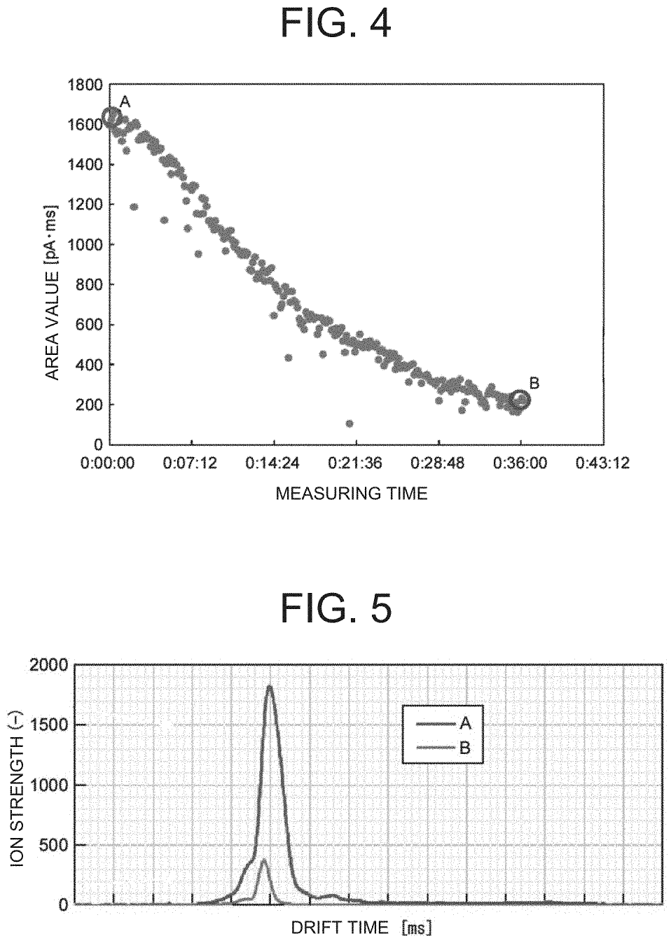

Measurement results are shown in FIG. 4 and FIG. 5. FIG. 4 is a graph showing the change in the total peak area of the current waveform of the measured recovery current, and FIG. 5 is a graph showing the current waveform of the recovery current immediately after the start of the measurement (A), and the current waveform of the recovery current 36 minutes after the start of the measurement (B). A large peak appearing in the current waveform in FIG. 5 is the peak of primary ions formed from the air or water.

As can be seen from the measurement results shown in FIGS. 4 and 5, after the start of the measurement, the peak appearing in the current waveform was large and the total peak area was also large, but as the measurement was repeated, the total peak area gradually became smaller and the total peak area after about 36 minutes from the start of the measurement was about one-eighth of the total peak area after the start of the measurement.

These results confirm that, in the IMS measurement using the electron discharge element, the output (electron discharge performance) of the electron discharge element gradually decreases with repetition of the IMS measurement. In the conventional measurement method, the electron discharge element was replaced when the device output decreases. However, the experiment is temporarily stopped by replacing the element every time the output decreases.

The reason for the gradual decrease in the output of the electron discharge element with the repeated IMS measurement is not clear; it is deemed, however, that the above is due to that the analysis chamber 30 is in a low-humidity environment, and driving the electron discharge element in this low-humidity environment may decrease the current path of the intermediate layer 5.

First Demonstrative Experiment of Forming Process

The IMS measurements were repeated using the drift tube-method IMS analyzer as shown in FIG. 1 thereby to execute the forming process under the condition that the output of the electron discharge element was decreased, thus executing an experiment to demonstrate the effect of the forming process.

The IMS measurements were repeated as in the first IMS experiment.

When executing the forming process, the dry air was distributed to the analysis chamber 30 as a drift gas, and the air (relative humidity: 80%) including the pure water volatile gas as a forming process gas was supplied from the gas introduction 16 to the analysis chamber 30. In the forming process, the start voltage was set to 17 V, the end voltage was set to 19 V, the number of boost steps was set to 20, the drive frequency was set to 1000 Hz, the number of drive times in each step was set to 1000, and the voltage boost amount between steps was set to 0.1 V.

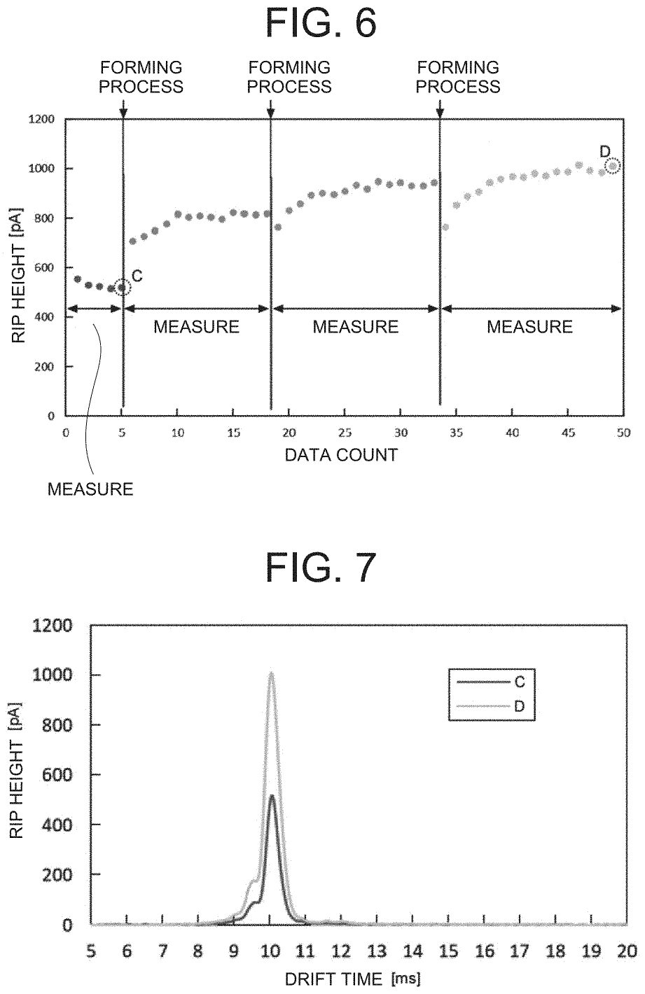

Measurement results are shown in FIG. 6 and FIG. 7. A total of three forming processes was executed at the timing indicated by arrows in FIG. 6. The IMS measurements were repeated before and after the forming process. A waveform C in the graph shown in FIG. 7 is the recovery current's waveform obtained from the IMS measurement indicated by C in FIG. 6, and a waveform D in the graph shown in FIG. 7 is the recovery current's waveform obtained by IMS measurement shown by D in FIG. 6. The large peaks appearing in the waveforms C and D are the peaks of air ions, and this peak height is the longitudinal axis in FIG. 6.

Executing the first forming process increased the peak height from about 500 pA to about 700 pA, and then repeating the IMS measurement gradually increased the peak height. In addition, executing the second and third forming processes decreased the peak height in the IMS measurement immediately after the process, and then repeating the IMS measurement, however, gradually increased the peak height. Finally, as shown in FIG. 7, the air ion peak height of the waveform D was about twice the air ion peak height of the waveform C.

In this way, it has been demonstrated that even when the output of the electron discharge element is decreased, executing the forming process can recover the output of the electron discharge element.

The forming process was executed while the air including ethanol volatile gas as the forming process gas was supplied from the gas introduction 16 to the analysis chamber 30, and then it has been confirmed that the output of the electron discharge element was likewise recovered.

Second IMS Experiment

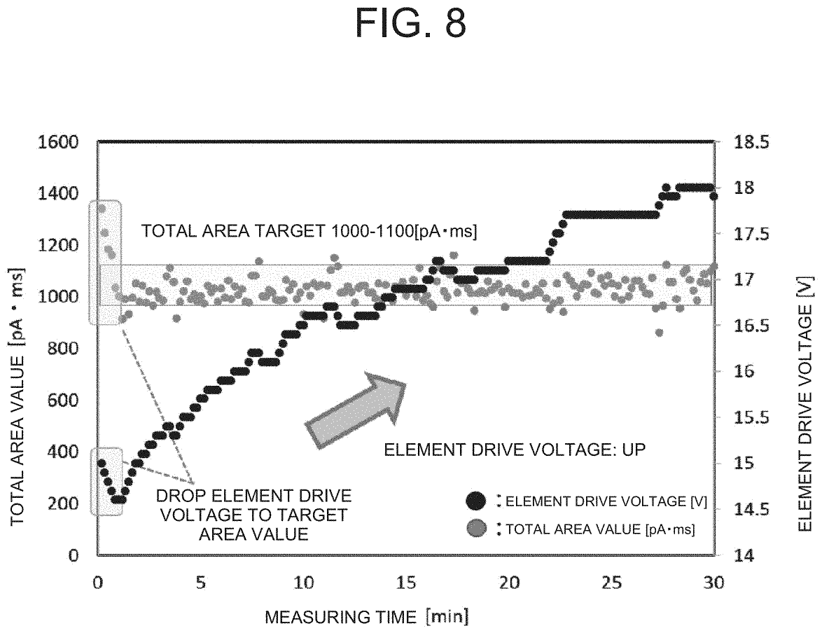

With the drift tube-method IMS analyzer as shown in FIG. 1, the IMS measurement was repeated while executing the control as shown in the flowchart in FIG. 2. The upper limit Sᵤₚₗᵢₘᵢₜ of the total peak area S of the current waveform of the recovery current was set to 1100 pA ms, and the lower limit S_{lowlimit} of the total peak area S was set to 1000 pA ms. Further, the initial voltage Vo of the element drive voltage V was set to 15 V. Other measurement conditions are the same as those in the first IMS experiment. Measurement results are shown in FIG. 8.

Immediately after the start of the measurement, since the total peak area S is more than the Sᵤₚₗᵢₘᵢₜ, the element drive voltage V decreased to 14.6 V, then the element drive voltage V gradually increased, and the element drive voltage V reached 18 V 30 minutes after the start of the measurement. This is because the output of the electron discharge element gradually decreases as IMS measurements are repeated.

The total peak area S corresponds to the total discharge amount that arrived at the collector 6 in the IMS measurement, and this total charge amount corresponds to the ion amount in the ionization area 10. Therefore, it has been found that, with the control shown in FIG. 2, the total charge amount arriving at the collector 6 can be stabilized with a variation suppressed as shown in the measurement results in FIG. 8, making it possible to stabilize the ion amount in the ionization area 10. Therefore, it has been found that the IMS measurement using such control makes it possible to execute the quantitative measurement.

It has also been found that it is difficult to continue the measurement with the element drive voltage V gradually increased and reaching the upper limit.

Second Demonstrative Experiment of Forming Process

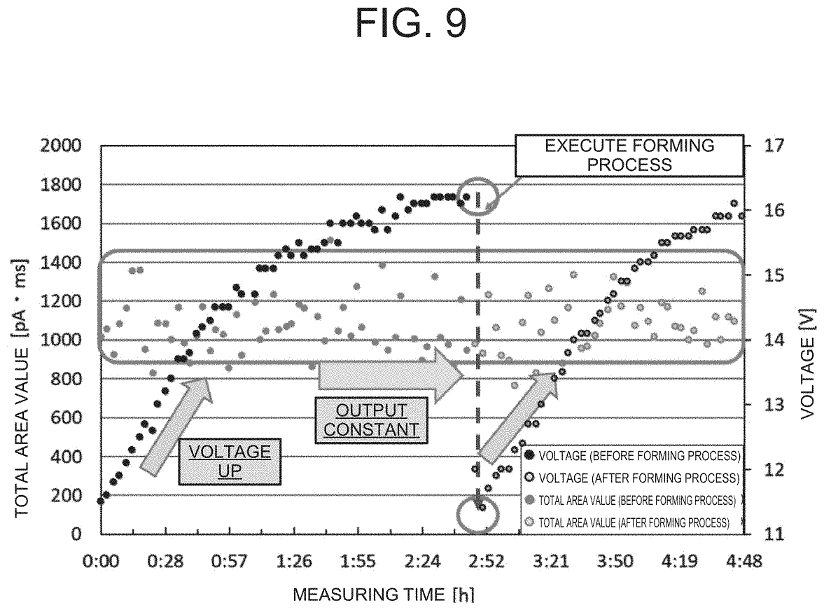

With the drift tube-method IMS analyzer as shown in FIG. 1, the IMS measurement was repeatedly executed while executing the control as shown in the flowchart in FIG. 3. The forming process was executed with the decreased output of the electron discharge element. The upper limit Sᵤₚₗᵢₘᵢₜ of the total peak area S of the current waveform of the recovery current was set to 1400 pA ms, and the lower limit S_{lowlimit} of the total peak area S was set to 900 pA ms. The initial voltage Vo of the element drive voltage V was set to 12 V. The method of the forming process is the same as that in the first demonstrative experiment. Any other measurement condition is the same as that in the first IMS experiment. Measurement results are shown in FIG. 9.

The element drive voltage immediately after the start of the measurement was around 11.5 V, and after 2 hours and 50 minutes from the start of the measurement, however, the element drive voltage reached around 16 V. Therefore, it has been found that executing the forming process and restarting the measurement decreased the element drive voltage to around 11.5 V. Therefore, it has been found that executing the forming process every time the element drive voltage reaches the upper limit Vᵤₚₗᵢₘᵢₜ makes it possible to repeat the IMS measurement for a long period of time with a stable output.

What is claimed is:

1. An ionizer, comprising:
a housing;
an electron discharge element arranged in the housing;
a controller; and
a gas introduction,
wherein
the electron discharge element has
a bottom electrode,
a surface electrode, and
an intermediate layer arranged between the bottom electrode and the surface electrode, and
the controller is
so set as to apply a voltage to across the bottom electrode and the surface electrode, and
so set as to execute a forming process when an electron discharge performance of the electron discharge element is decreased, and
the forming process is a process of applying, in a state where a forming process gas is introduced into the housing by using the gas introduction, a forming voltage to across the bottom electrode and the surface electrode using the controller.

2. The ionizer according to in claim 1, wherein the forming process gas is a gas with a relative humidity of 60% or more or a gas containing ethanol.

3. The ionizer according to in claim 1, wherein
the controller is
so set as to apply a voltage of a first voltage or more to a second voltage or less to across the bottom electrode and the surface electrode thereby to discharge an electron from the electron discharge element, thus directly or indirectly ionizing a target gas with the electron, and
so set as to, in the forming process, apply a voltage more than the second voltage to across the bottom electrode and the surface electrode.

4. The ionizer according to in claim 1, wherein
in the forming process, the controller is so set as to increase, step by step at a boost rate of 0.05 V/sec or more to 1 V/sec or less, the forming voltage applied to across the bottom electrode and the surface electrode.

5. The ionizer according to in claim 1, wherein
in the forming process, the controller is so set as to repeatedly switch on/off, at a frequency of 500 Hz or more to 5000 Hz or less, the forming voltage applied to across the bottom electrode and the surface electrode.

6. The ionizer according to claim 1, wherein the intermediate layer is a silicone resin layer having a silver particle in a dispersed state.

7. An IMS analyzer comprising:
the ionizer according to claim 1;
a collector; and
an electric field former,
wherein
the electric field former is so set as to form an electric field in an ion mobile area where an ion directly or indirectly generated by an electron discharged from the electron discharge element moves toward the collector, and
the collector and the controller are so set as to measure a current waveform of a current caused to flow as the ion arrives at the collector.

8. The IMS analyzer according to in claim 7, wherein the controller is so set as to adjust the applied voltage to across the bottom electrode and the surface electrode based on the current waveform.

9. The IMS analyzer according to in claim 8, wherein
the controller is
so set as to increase the applied voltage to the bottom electrode and the surface electrode when a peak area or peak height of the current waveform becomes less than a predetermined value, and
so set as to execute the forming process when the peak area or the peak height of the current waveform in a measurement immediately after increasing the applied voltage to the bottom electrode and the surface electrode becomes less than the predetermined value.
